(19) United States
(12) Patent Application Publication
(10) Pub. No.: US 2014/0063307 A1
(43) Pub. Date: Mar. 6, 2014

(54) CAMERA MODULE WITH SEALING GLUE

(71) Applicant: HON HAI PRECISION INDUSTRY CO., LTD., New Taipei (TW)

(72) Inventor: HONG-KUN WANG, New Taipei (TW)

(73) Assignee: HON HAI PRECISION INDUSTRY CO., LTD., New Taipei (TW)

(21) Appl. No.: 13/736,932

(22) Filed: Jan. 8, 2013

(30) Foreign Application Priority Data
Aug. 28, 2012 (TW) 101131203

(51) Int. Cl. H04N 5/225

(52) U.S. Cl. CPC H04N 5/2254
USPC 348/302

(57) ABSTRACT

An exemplary camera module includes a substrate, a holler lens holder, an image sensor, a cover glass, a passive element, and glue. The hollow lens holder is positioned on the substrate and includes an internal annular plate spaced from the substrate. The image sensor is positioned on the substrate and including a central active area. The cover glass is positioned between the image sensor and the annular plate. The active area is exposed through a center of the cover glass and via the annular plate. The passive element positioned on the substrate, within the lens holder. The glue is applied between the cover glass and the annular plate to seal a passage formed between the cover glass and the annular plate, thereby preventing particles detaching from the passive element from migrating to the center of the cover glass.

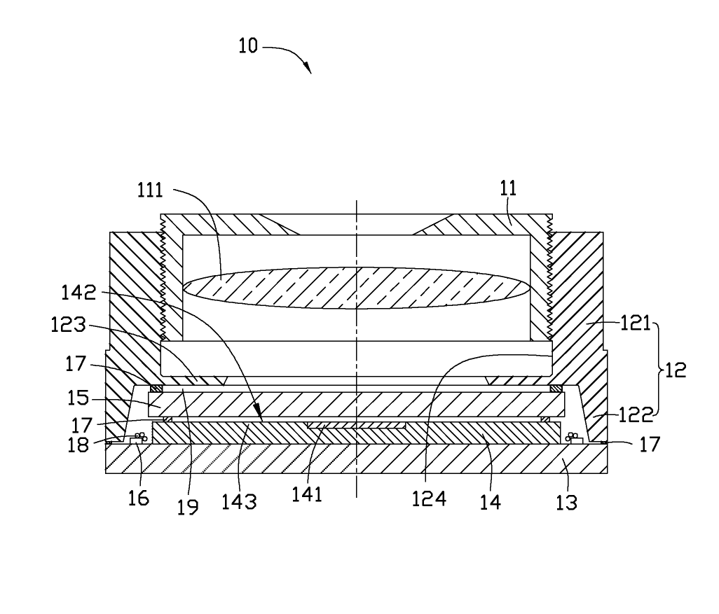

### BACKGROUND

1. Technical Field

The present disclosure relates to camera modules used in cameras.

2. Description of Related Art

A typical camera module includes a substrate, an image sensor, a number of passive elements, a cover glass, a lens holder, and a lens. The image sensor and the passive elements, such as resistors and capacitors, are positioned on and electrically connected to the substrate to form complete circuits for image capturing and processing. The cover glass is positioned over and covers the image sensor to protect the image sensor from being damaged and contaminated. The lens holder is also positioned on the substrate and covers the image sensor, the passive elements, and the cover glass. The lens is held in the lens holder. The image sensor is exposed to the lens through the cover glass and is configured for capturing optical images formed by the lens. However, particles may detach from the passive elements and float and fall onto the cover glass. When the cover glass becomes contaminated, the quality of the images captured is degraded.

Therefore, it is desirable to provide a camera module which can overcome the above-mentioned problems.

### BRIEF DESCRIPTION OF THE DRAWING

Many aspects of the present disclosure can be better understood with reference to the following drawing.

The drawing is a cross-sectional view of a camera module, according to an embodiment of the present disclosure.

### DETAILED DESCRIPTION

Embodiments of the present disclosure will now be described in detail with reference to the drawing.

The drawing shows a camera module 10 according to an embodiment. The camera module 10 includes a lens unit 11, a lens holder 12, a substrate 13, an image sensor 14, a cover glass 15, a number of passive elements 16, and glue (adhesive) 17. The image sensor 14 and the passive elements 16 are positioned on and electrically connected to the substrate 13 to form complete circuits for image capturing and processing. The passive elements 16 surround the image sensor 14. The cover glass 15 is positioned above and covers the image sensor 14 to protect the image sensor 14 from being damaged and contaminated. The lens holder 12 is also positioned on the substrate 13, and covers the passive elements 16 and peripheral portions of the image sensor 14 and the cover glass 12. The lens holder 12 includes an inner sidewall 124, and an annular plate 123 extending inward from the inner sidewall 124 along a direction that is substantially parallel with the substrate 13. The annular plate 123 is positioned at a side of the cover glass 15 opposite to the side of the cover glass 15 facing the image sensor 14, and is close to the cover glass 15. The lens unit 11 includes a central lens 111. The lens unit 11 is held in the lens holder 12, aligning with the image sensor 14. The image sensor 14 includes a central active area 141. The active area 141 is exposed to the lens unit 11 through the cover glass 15 and the annular plate 123, and is configured for capturing optical images formed by the lens unit 11.

The glue 17 is applied between the cover glass 15 and the annular plate 123, to seal a passage 19 from the passive elements 16 to a center of the cover glass 15. In this embodiment, the glue 17 is in the form of a ring, and blocks migration of particles 18 from the passive elements 16 through the passage 19. Thus, a portion of the cover glass 15 through which the optical images are directed is free from contamination by the particles 18, and the quality of the optical images captured is ensured.

The lens unit 11 can be threadedly engaged with the lens holder 12.

The lens holder 12 includes a first tubular portion 121, and a second tubular portion 122 connecting with the first tubular portion 121. The annular plate 123 is positioned between the first tubular portion 121 and the second tubular portion 122. In this embodiment, the first tubular portion 121 is a circular cylinder, and is configured for receiving the lens unit 11. The second tubular portion 122 is rectangular, and is configured for receiving the image sensor 14 and the cover glass 15 (both of which are commonly rectangular). The lens holder 12 can be fixed to the substrate 13 by the glue 17 too.

The substrate 13 can be a printed circuit board or a flexible printed circuit board.

The image sensor 14 can be a charge-coupled device (CCD) sensor or a complementary metal oxide semiconductor (CMOS) sensor. The image sensor 14 includes an upper surface 142 facing away from the substrate 13. The active area 141 is formed in the upper surface 142, generally at a center of the upper surface 142. The upper surface 141 also includes an inactive area 143 surrounding the active area 141. The glue 17 is also applied between the inactive area 143 and the cover glass 15, to seal a passage from the passive elements 16 to the active area 141. In this embodiment, the glue 17 is in the form of a ring, and blocks migration of the particles 18 from the passive elements 16 through the passage. Thus, the active area 141 is prevented from being contaminated by the particles 18.

The cover glass 15 can be a transparent glass plate, or a transparent glass plate coated with any of various optical films for light filtering as required.

The passive elements 16 can be resistors, capacitors, and/or inductors.

The glue 17 can be black glue.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A camera module, comprising:
a substrate;
an image sensor comprising an active area;
a passive element, the image sensor and the passive element being positioned on and electrically connected to the substrate, the passive element located at a periphery of the image sensor;
a cover glass positioned above and covering the image sensor;
a lens holder positioned on the substrate and covering at least portions of the image sensor, the passive element, and the cover glass, the lens holder comprising an inner sidewall and an annular plate extending inward from the inner sidewall, the annular plate being positioned close to the cover glass at a side of the cover glass opposite to a side of the cover glass facing the image sensor;
a lens held in the lens holder and aligning with the image sensor, the active area of the image sensor being exposed to the lens through the cover glass and via the annular plate; and
glue applied between the cover glass and the annular plate to block passage of particles from the passive element to a center of the cover glass.

2. The camera module of claim 1, further comprising a lens unit, wherein the lens is received in the lens unit, and the lens unit is threadedly engaged with the lens holder.

3. The camera module of claim 1, wherein the lens holder comprises a first tubular portion and a second tubular portion connecting with the first tubular portion, the annular plate is positioned between the first tubular portion and the second tubular portion, the first tubular portion is configured for receiving the lens, and the second tubular portion is configured for receiving the image sensor and the cover glass.

4. The camera module of claim 1, wherein the lens holder is fixed to the substrate by the glue.

5. The camera module of claim 1, wherein the substrate is one of a printed circuit board and a flexible printed circuit board.

6. The camera module of claim 1, wherein the image sensor is one of a charge-coupled device sensor and a complementary metal oxide semiconductor sensor.

7. The camera module of claim 1, wherein the image sensor comprises an upper surface facing away from the substrate, and the active area is formed in the upper surface at a center of the upper surface.

8. The camera module of claim 7, wherein the upper surface comprises an inactive area surrounding the active area, and the glue is also applied between the inactive area and the cover glass to block passage of the particles from the passive element to the active area.

9. The camera module of claim 1, wherein the cover glass is a transparent glass.

10. The camera module of claim 1, wherein the passive element is selected from the group consisting of a resistor, a capacitor and an inductor.

11. The camera module of claim 1, wherein the glue is black glue.

12. The camera module of claim 1, wherein the glue is in the form of a ring.

13. A camera module, comprising:
a substrate;
a hollow lens holder positioned on the substrate and including an internal annular plate spaced from the substrate;
an image sensor positioned on the substrate and including a central active area;
a cover glass positioned between the image sensor and the annular plate, the active area being exposed through a center of the cover glass and via the annular plate;
a passive element positioned on the substrate, within the lens holder; and
glue applied between the cover glass and the annular plate to seal a passage formed between the cover glass and the annular plate, thereby preventing particles detaching from the passive element from migrating to the center of the cover glass.
